(19) United States
(12) Patent Application Publication
(10) Pub. No.: US 2011/0226711 A1
(43) Pub. Date: Sep. 22, 2011

(54) TRANSPORTATION TRAY

(76) Inventors: Michikazu Okanishi, Osaka (JP); Ryo Uematsu, Osaka (JP); Kimio Nagatome, Osaka (JP)

(21) Appl. No.: 13/130,599

(22) PCT Filed: Jul. 27, 2009
(86) PCT No.: PCT/JP2009/003525

§ 371 Date: May 23, 2011

(30) Foreign Application Priority Data
Dec. 4, 2008 (JP) 2008-310288

(51) Int. Cl. B65D 85/86; F16M 13/00

(52) U.S. Cl. 211/41.1

(57) ABSTRACT

A cushioned top surface mat on which a plurality of devices are to be placed is provided on the top surface of a tray body. A bottom surface mat which is brought into contact with a plurality of devices placed on a lower tray body to restrict movement of the devices is provided on the bottom surface of the tray body.

### TECHNICAL FIELD

The present invention relates to transportation trays.

### BACKGROUND ART

As transportation trays used in a factory for fabricating display devices such as liquid crystal display devices, for transporting plate-like devices such as display panels and display modules to a next fabrication process, trays having a plurality of holding recesses, each for holding one of such devices, and capable of being stacked in multiple layers have been known (see, e.g., Patent Document 1). In such a transportation tray, each of the holding recesses is designed according to the size and shape of the device to be held in the holding recess to restrict movement of the devices in the respective holding recesses during transportation and prevent the devices from being damaged by vibration or shock during transportation.

### CITATION LIST

### Patent Document

Patent Document 1: Japanese Patent Publication No. H11-198938

### SUMMARY OF THE INVENTION

### Technical Problem

In order to restrict movement of the devices during transportation, each of the holding recesses of the above transportation trays needs to be designed according to the size and shape of the device to be held in the holding recess. Thus, for liquid crystal display panels which have different size specifications, or liquid crystal display modules whose overall shape is different depending on the mounting location and the shape of the circuit board mounted, a plurality of types of transportation trays with holding recesses different in size or shape according to the devices are necessary. To form the various types of transportation trays, dedicated molds are necessary, which requires considerable cost. Moreover, in the case where a plurality of types of transportation trays are used, the stock of the transportation trays may not be well controlled because the transportation trays need to be controlled according to type. In addition, the transportation trays for those devices whose production has been discontinued become useless, which leads to an increase in amount of stock.

The present invention was made in view of the above problems, and it is an objective of the invention to restrict movement of the devices during transportation and to provide trays capable of holding devices having different size or shape.

### Solution to the Problem

To achieve the above objective, the present invention includes a cushioned top surface mat which is provided on the top surface of a tray body and on which a plurality of devices are to be placed, and a cushioned bottom surface mat which is provided on the bottom surface of the tray body and which is brought into contact with a plurality of devices placed on a lower tray body to restrict movement of the plurality of devices.

Specifically, a transportation tray according to the present invention includes a tray body for holding a plurality of plate-like devices in an array, and capable of being stacked in multiple layers, wherein a cushioned top surface mat on which the plurality of devices are placed is provided on a top surface of the tray body, and a cushioned bottom surface mat which is brought into contact with a plurality of devices placed on a lower tray body to restrict movement of the plurality of devices is provided on a bottom surface of the tray body.

According to this structure, the bottom surface mat provided on an upper tray body is brought into contact with the held devices when the trays are stacked in multiple layers. Thus, the devices are held sandwiched between the top surface mat and the bottom surface mat of the upper tray body. This prevents the up-and-down movement of the devices, and the movement in a direction parallel to the bottom surface of the tray body. Thus, it is not necessary to form the transportation tray according to the size or shape of the devices to be held. For this reason, the devices to be held are not limited by their size or shape, and even if the size or shape of the devices to be held are changed, the devices can be properly held. This means that the movement of the devices during transportation can be restricted, and that the trays can hold the devices different in size or shape. Since the movement of the devices during transportation can be restricted, the devices can be prevented from being damaged by vibration or shock during the transportation. Further, since the tray is capable of holding devices different in size or shape, the transportation trays for the devices different in size or shape can be formed by the same molds. Moreover, stock control is simplified because it is not necessary to control the transportation trays according to type, and the cost is reduced because no transportation tray becomes useless even if production of some of the devices to be held is discontinued.

It is preferable that a positioning mark for indicating a mounting location of each of the plurality of devices is provided on the tray body.

According to this structure, when the devices are held, each of the devices can be positioned at a predetermined location by the positioning mark, and the number of devices to be held in the transportation tray can be easily controlled.

It is preferable that a positioning sheet marked with the positioning mark is provided between the tray body and the top surface mat.

According to this structure, even if production of devices having new size or shape which cannot be positioned by the positioning mark is started, the devices having new size or shape can also be positioned at a predetermined location, and the number of devices to be held in the transportation tray can be easily controlled, by adding another positioning mark according to the devices, or replacing the positioning sheet with a positioning sheet marked with a positioning mark according to the devices, for example.

The above devices may be a liquid crystal display module.

According to this structure, movement of the liquid crystal display modules during transportation is restricted, and the trays can be used for holding liquid crystal display modules different in size or shape.

### ADVANTAGES OF THE INVENTION

According to the present invention, a cushioned top surface mat on which a plurality of devices are to be placed is provided on the top surface of the tray body, and a cushioned bottom surface mat which is brought into contact with a plurality of devices placed on a lower tray body to restrict movement of the plurality of devices is provided on the bottom surface of the tray body. Thus, the movement of the devices during transportation can be restricted, and the trays can hold the devices in different size or shape.

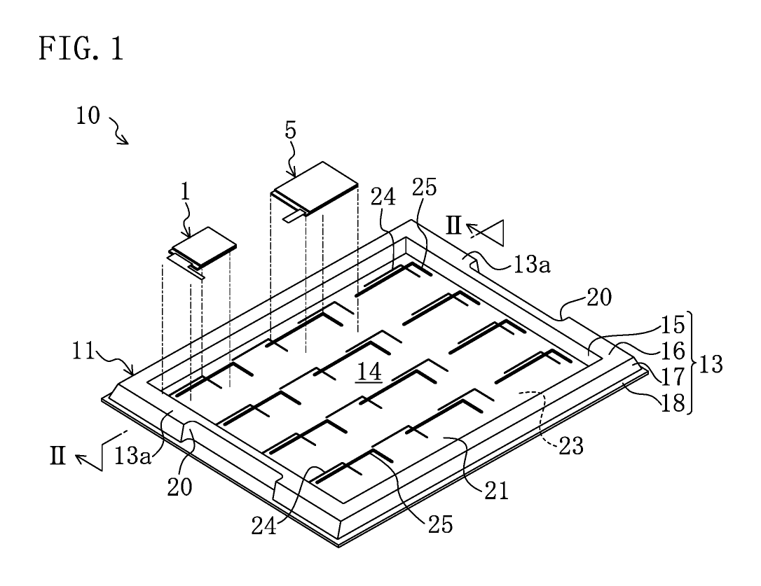

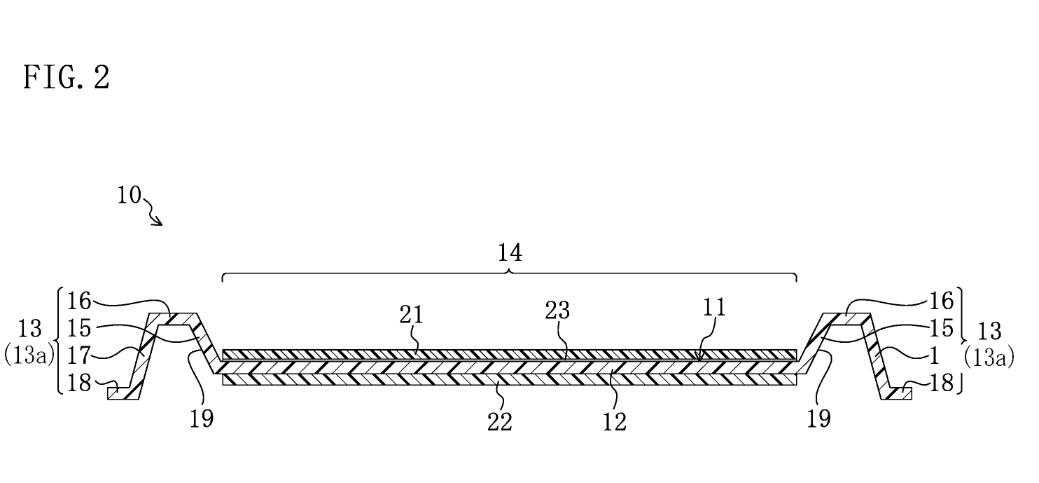

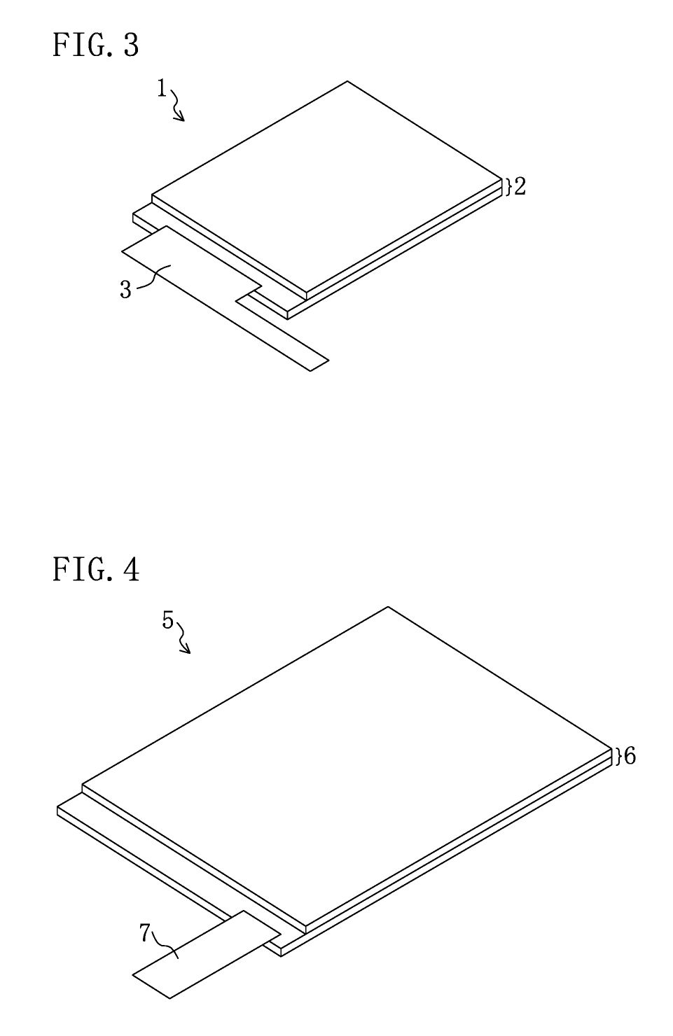

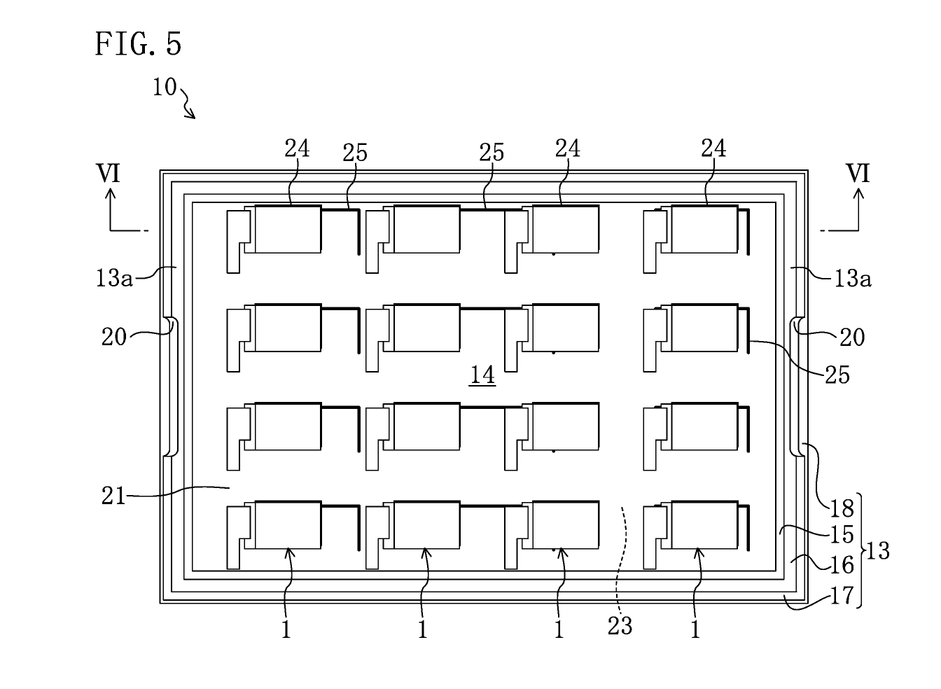

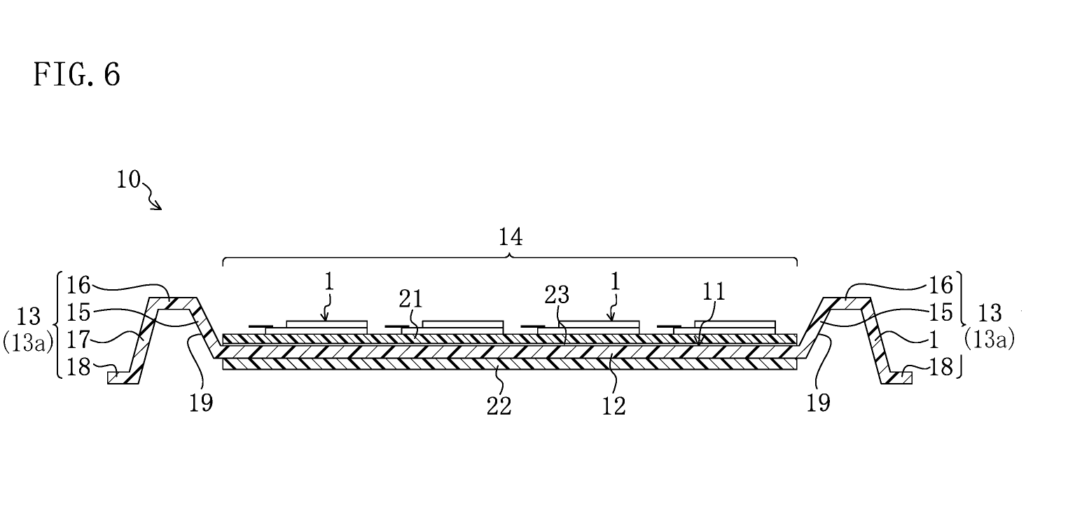

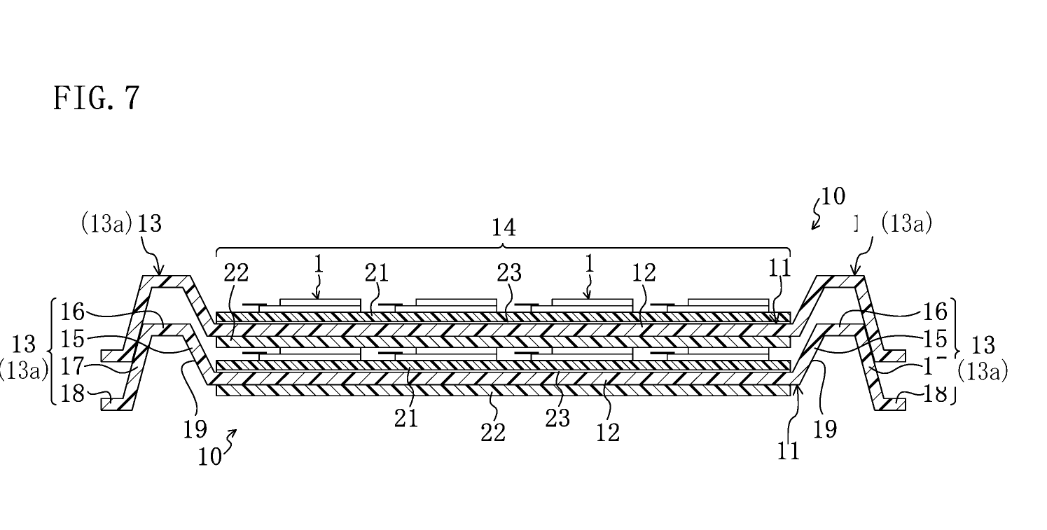

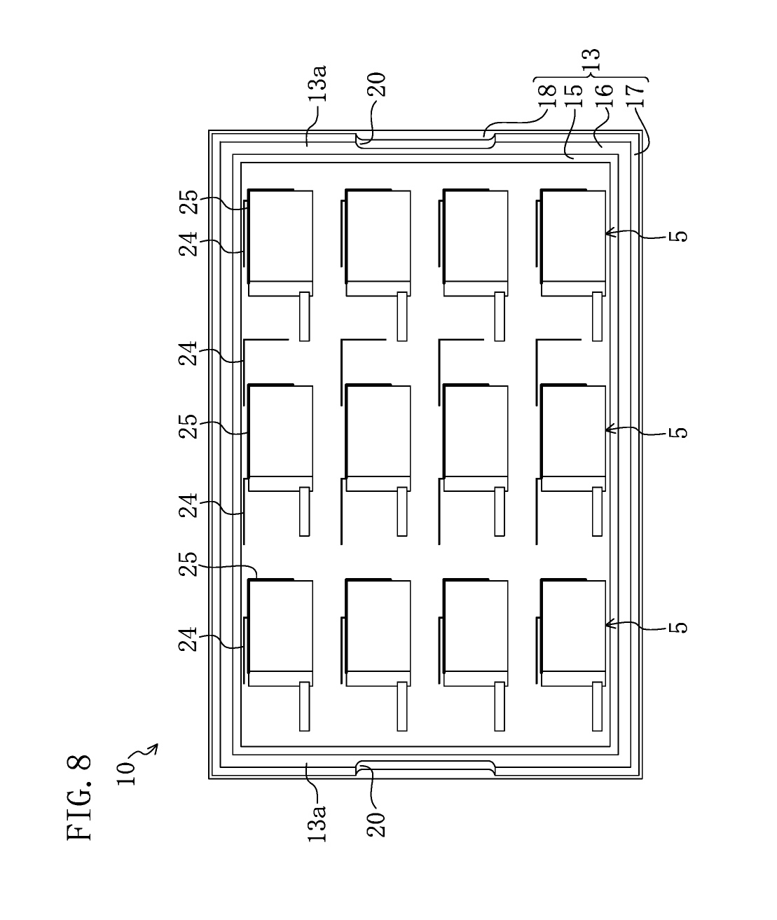

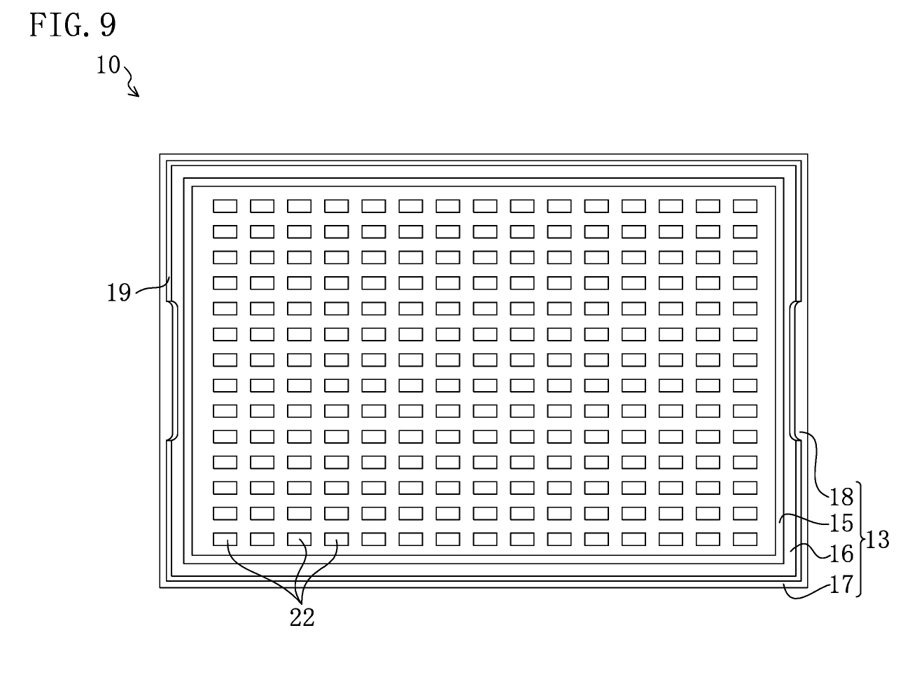

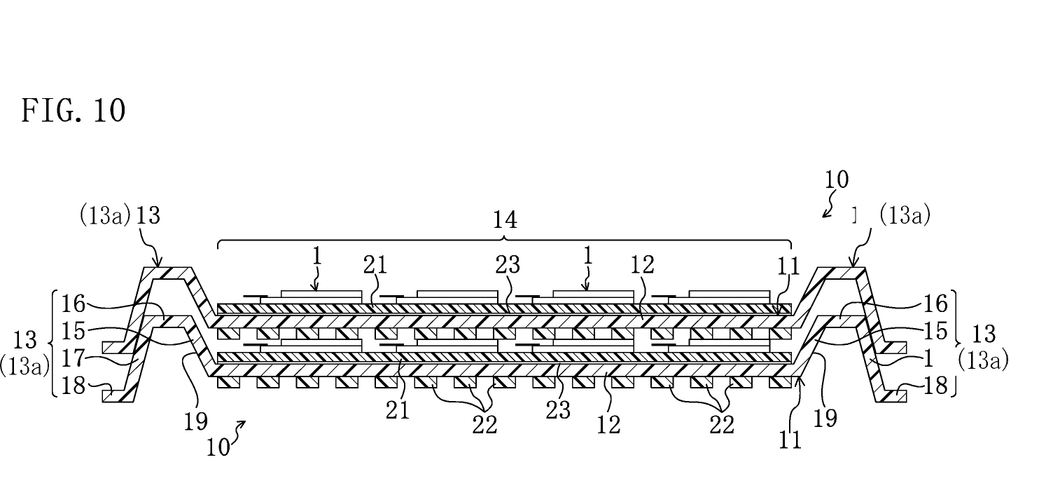

### BRIEF DESCRIPTION OF THE DRAWINGS

[FIG. 1] FIG. 1 is an oblique view for schematically showing a transportation tray of the first embodiment.

[FIG. 2] FIG. 2 is a schematic cross section taken along the line II-II in FIG. 1.

[FIG. 3] FIG. 3 is an oblique view for schematically showing a first liquid crystal display module.

[FIG. 4] FIG. 4 is an oblique view for schematically showing a second liquid crystal display module.

[FIG. 5] FIG. 5 is a plan view for schematically showing a transportation tray in which the first liquid crystal display module is held.

[FIG. 6] FIG. 6 is a schematic cross section taken along the line VI-VI in FIG. 5.

[FIG. 7] FIG. 7 is a cross section for schematically showing the stacked transportation trays of the first embodiment.

[FIG. 8] FIG. 8 is a plan view for schematically showing a transportation tray in which a second liquid crystal display module is held.

[FIG. 9] FIG. 9 is a plan view for schematically showing a transportation tray of the second embodiment, viewed from the bottom surface.

[FIG. 10] FIG. 10 is a cross section for schematically showing the stacked transportation trays of the second embodiment.

### DESCRIPTION OF EMBODIMENTS

Embodiments of the present invention will be described in detail hereinafter based on the drawings. The present invention is not limited to the following embodiments.

### First Embodiment of Invention

FIG. 1 to FIG. 8 show the first embodiment of the present invention. FIG. 1 is an oblique view for schematically showing a transportation tray 10 of the present embodiment. FIG. 2 is a cross section for schematically showing the transportation tray 10 taken along the line II-II in FIG. 1. FIG. 3 is an oblique view for schematically showing a first liquid crystal display module 1 to be held in the transportation tray 10. FIG. 4 is an oblique view for schematically showing a second liquid crystal display module 5 to be held in the transportation tray 10.

The transportation tray 10 is a tray for holding and transporting plate-like devices such as a liquid crystal display panel and a liquid crystal display module. In the present embodiment, a first liquid crystal display module 1 and a second liquid crystal display module 5 are described as examples of the devices to be held in the transportation tray 10. As shown in FIG. 3, the first liquid crystal display module 1 includes a relatively small, first liquid crystal display panel 2 in which a pair of substrates are attached to each other, with a liquid crystal layer interposed between the pair of substrates, and includes a first flexible printed circuit 3 (hereinafter referred to as “FPC”), etc., mounted to the first liquid crystal display panel 2. As shown in FIG. 4, the second liquid crystal display module 5 includes a second liquid crystal display panel 6 which is larger in size than the first liquid crystal display panel 2, and a second FPC 7, etc. which is different in shape from the first FPC 3 and which is mounted to the second liquid crystal display panel 6.

The transportation tray 10 is a so-called “free tray” capable of holding a plurality of devices in an array. As shown in FIG. 1 and FIG. 2, the transportation tray 10 includes a tray body 11 molded into a rectangular plate-like shape.

The tray body 11 is made of such as polypropylene, and is designed to be capable of being stacked in multiple layers. The tray body 11 includes, as shown in FIG. 2, a bottom portion 12 having a flat bottom surface, and a side wall portion 13 which is located around the entire periphery of the bottom portion 12 and which protrudes upward. The tray body 11 has a holding portion 14 surrounded by the side wall portion 13, for holding a plurality of devices.

The side wall portion 13 includes: an inner wall portion 15 which extends upward and is tilted outward with respect to the bottom portion 12; a top portion 16 which extends outward from an upper portion of the inner wall portion 15 in parallel with the bottom portion 12; an outer wall portion 17 which extends downward from an outer end of the top portion 16 and is tilted outward with respect to the bottom portion 12; and a flange portion 18 which protrudes outward from a lower end of the outer wall portion 17. A positioning recess 19 partitioned by the inner wall portion 15, the top portion 16, and the outer wall portion 17 is formed under the side wall portion 13. To stack the transportation trays 10 in multiple layers, the positioning recess 19 is fitted to the side wall portion 13 of a lower tray body 11, thereby preventing misalignment of the transportation trays 10.

As shown in FIG. 1, the side wall portion 13 is provided with a handle recess 20 at each of a pair of side portions 13a facing each other along a longitudinal direction. The entire lower portion of the handle recess 20 is partitioned by the flange portion 18. With this structure, the transportation trays 10 can be easily stacked and detached. Another function of the handle recess 20 is to prevent the tray body 11 from being deformed by external shock. Thus, the devices are protected from the load applied to the devices due to the deformation of the tray body 11.

A positioning sheet 23 marked with a positioning mark for indicating a mounting location of each device is placed on the top surface of the bottom portion 12. In the present embodiment, a predetermined number of first positioning marks 24 for indicating a location at which the first liquid crystal display module 1 is placed, and a predetermined number of second positioning marks 25 for indicating a location at which the second liquid crystal display module 5 is placed, are marked in a matrix on the positioning sheet 23 as positioning marks.

As shown in FIG. 2, a cushioned top surface mat 21 on which a plurality of devices are to be placed is integrally formed on the positioning sheet 23 to cover almost the entire surface of the bottom portion 12. Further, a cushioned bottom surface mat 22 is attached to the bottom surface of the bottom portion 12 at a location corresponding to the top surface mat 21, i.e., almost the entire bottom surface of the bottom portion 12. When the transportation trays 10 are stacked in multiple layers, the bottom surface mat 22 is brought into contact with the devices held in a lower transportation tray 10 to restrict movement of the devices.

As the top surface mat 21 and the bottom surface mat 22, a transparent mat made of foamed polyethylene, etc. and subjected to an antistatic treatment, such as “MIRAMAT A” produced by JSP Corporation, can be used. Here, the term “transparent mat” includes not only a colorless, transparent mat, but also a colored transparent mat and a slightly white translucent mat.

As described above, the transportation tray 10 is configured to hold a plurality of devices between the top surface mat 21 and the bottom surface mat 22 of the upper transportation tray 10 when the transportation trays 10 are stacked with the plurality of devices held in the holding portion 14.

Method of Use

Now, how to use the transportation tray 10 will be described with reference to FIG. 5 to FIG. 8. FIG. 5 is a plan view for schematically showing the transportation tray 10 in which the first liquid crystal display modules 1 are held. FIG. 6 is a cross section for schematically showing the transportation tray 10 taken along the line VI-VI in FIG. 5. FIG. 7 is a cross section for schematically showing the stacked transportation trays 10. FIG. 8 is a plan view for schematically showing the transportation tray 10 in which the second liquid crystal display modules 5 are held.

To transport devices using the transportation tray 10, each of the devices is positioned at a predetermined location in the holding portion 14 according to the positioning marks 24, 25 which can be visually recognized through the top surface mat 21, thereby holding a predetermined number of devices corresponding to the positioning marks in a plurality of transportation trays 10. For example, to hold a plurality of first liquid crystal display modules 1 in the transportation tray 10, the first liquid crystal display modules 1 are placed on the top surface mat 21, with the periphery of each first liquid crystal display module 1 in alignment with the first positioning mark 24, while leaving space between each other as shown in FIG. 5 and FIG. 6.

Then, as shown in FIG. 7, the plurality of transportation trays 10 each holding the first liquid crystal display modules 1 are stacked by fitting the positioning recess 19 of the upper tray 10 to the side wall portion 13 of the lower tray 10. Preparation for the transportation of the first liquid crystal display modules 1 is completed when an empty tray 10 is stacked on the top. The first liquid crystal display modules 1 held in the transportation trays 10 are maintained sandwiched between the top surface mat 21 and the bottom surface mat 22 of the upper tray 10.

To hold a plurality of second liquid crystal display modules 5 in the transportation tray 10, the second liquid crystal display modules 5 are placed on the top surface mat 21, with the periphery of each second liquid crystal display module 5 in alignment with the second positioning mark 25, while leaving space between each other as shown in FIG. 8. After placing the plurality of second liquid crystal display modules 5 in the holding portions 14 of the plurality of transportation trays 10, the plurality of transportation trays 10 are stacked by the same method as used when the first liquid crystal display modules 1 are held. Preparation for the transportation of the second liquid crystal display modules 5 is completed when an empty tray 10 is stacked on the top. The second liquid crystal display modules 5 held in the transportation trays 10 are maintained sandwiched between the top surface mat 21 and the bottom surface mat 22 of the upper tray 10, as in the case where the first liquid crystal display modules 1 are held.

To remove the devices from the plurality of stacked transportation trays 10 after the transportation of the transportation trays 10, hands are inserted in the pair of handle recesses 20 of a lower tray 10 to hold the flange portion 18 of the upper tray 10, thereby detaching, for example, a plurality of transportation trays 10 from the lower tray 10 from top to down. Then, the devices are taken from the transportation trays 10.

The present embodiment was described using the first liquid crystal display module 1 and the second liquid crystal display module 5 as examples of the devices to be held in the transportation tray 10. However, the transportation tray 10 is capable of holding and transporting liquid crystal display panels 2, 6 which form the liquid crystal display modules 1, 5, as well as substrates, etc. which form the liquid crystal display panels 2, 6.

Effects of First Embodiment

As described, according to the first embodiment, the bottom surface mat 22 provided on an upper tray body 11 is brought into contact with the held devices when the transportation trays 10 are stacked in multiple layers. Thus, the devices are held sandwiched between the top surface mat 21 and the bottom surface mat 22 of the upper tray body 11. This prevents the up-and-down movement of the devices, and the movement in a direction parallel to the bottom surface of the holding portion 14. Thus, it is not necessary to form the transportation tray 10 according to the size or shape of the devices to be held. For this reason, the devices to be held are not limited by their size or shape, and even if the size or shape of the devices to be held are changed, the devices can be properly held. This means that the movement of the devices during transportation can be restricted, and that the trays can hold the devices different in size or shape. Since the movement of the devices during transportation can be restricted, the devices can be prevented from being damaged by vibration or shock during the transportation. Further, since the transportation tray 10 is capable of holding devices different in size or shape, the transportation trays 10 for the devices different in size or shape can be formed by the same molds. Moreover, it is possible to simplify stock control because it is not necessary to control the transportation trays 10 according to type, and the cost can be reduced because no transportation tray 10 becomes useless even if production of some of the devices to be held is discontinued.

The positioning sheet 23 marked with the positioning marks 24, 25 for indicating a mounting location of each device is placed between the tray body 11 and the top surface mat 21. Thus, when the devices are held, the devices can be positioned at a predetermined location by the positioning marks 24, 25, and the number of devices to be held in the transportation tray 10 can be easily controlled. Even if production of devices having new size or shape which cannot be positioned by the positioning marks 24, 25 is started, the devices having new size or shape can also be positioned at a predetermined location, and the number of devices to be held in the transportation tray 10 can be easily controlled, by adding another positioning mark according to the devices, or replacing the positioning sheet with a positioning sheet marked with a positioning mark according to the devices, for example.

### Second Embodiment of Invention

FIG. 9 and FIG. 10 show the second embodiment of the present invention. In the following embodiments, the same reference numerals are used to represent the same elements shown in FIG. 1 to FIG. 8, and a detailed description thereof is omitted. FIG. 9 is a plan view for schematically showing a transportation tray 10 of the present embodiment, viewed from the bottom surface. FIG. 10 is a cross section for schematically showing the stacked transportation trays 10 of the present embodiment.

In the first embodiment, the bottom surface mat 22 is integrally attached to almost the entire bottom surface of the bottom portion 12 of the tray body 11. However, according to the transportation tray 10 of the present embodiment, a plurality of bottom surface mats 22 are provided in a matrix to almost the entire bottom surface of the bottom portion 12 of the tray body 11, as shown in FIG. 9. The structures other than the bottom surface mat 22 are the same as those in the first embodiment.

The method of use of the transportation tray 10 is the same as that described in the first embodiment. For example, in the case where the first liquid crystal display module 1 is held in the transportation tray 10, a plurality of first liquid crystal display modules 1 are held in a plurality of transportation trays 10 in alignment with the respective first positioning marks 24. A plurality of transportation trays 10 holding the first liquid crystal display modules 1 are stacked as shown in FIG. 10, and an empty tray 10 is stacked on the top. The first liquid crystal display modules 1 held in the transportation trays 10 are maintained sandwiched between the top surface mat 21 and part of the plurality of bottom surface mats 22 of the upper tray 10.

Effects of Second Embodiment

As described above, according to the second embodiment as well, like the first embodiment, the devices are held sandwiched between the top surface mat 21 and part of the plurality of bottom surface mats 22 when the transportation trays 10 are stacked in multiple layers. This prevents the up-and-down movement of the devices, and the movement in a direction parallel to the bottom surface of the holding portion 14. This means that the movement of the devices during transportation can be restricted, and that the trays can hold the devices different in size or shape.

### Other Embodiments

In the first embodiment, the positioning marks 24, 25 are marked on the positioning sheet 23 placed between the tray body 11 and the top surface mat 21. However, the present invention is not limited to this structure, and the positioning marks 24, 25 may be marked directly on the tray body 11. In the case where the positioning marks 24, 25 are marked on the tray body 11, as well, the devices can be positioned at a predetermined location by the positioning marks 24, 25 when the devices are held, and the number of devices to be held in the transportation tray 10 can be easily controlled.

In the first embodiment, the first liquid crystal display module 1 and the second liquid crystal display module 5 were described as examples of the devices to be held in the transportation tray 10, and the transportation tray 10 was described as being capable of holding and transporting liquid crystal display panels 2, 6 which form the liquid crystal display modules 1, 5, as well as substrates, etc. which form the liquid crystal display panels 2, 6. However, the present invention is not limited to this structure. The transportation tray 10 can be used as a tray for holding and transporting a display panel, a display module, etc., which form a different display device, such as an organic electroluminescent display device and a plasma display device, or can be used as a tray for transporting any plate-like devices.

### INDUSTRIAL APPLICABILITY

As described above, the present invention is useful as a transportation tray, and particularly suitable as a transportation tray which is desired to restrict movement of devices during transportation, and to be capable of being used for devices different in size or shape.

### DESCRIPTION OF REFERENCE CHARACTERS

1 first liquid crystal display module

5 second liquid crystal display module

10 transportation tray

14 holding portion

21 top surface mat

22 bottom surface mat

23 positioning sheet

24 first positioning mark

25 second positioning mark

1. A transportation tray, comprising:
a tray body for holding a plurality of plate-like devices in an array, and capable of being stacked in multiple layers, wherein
a cushioned top surface mat on which the plurality of devices are placed is provided on a top surface of the tray body, and
a cushioned bottom surface mat which is brought into contact with a plurality of devices placed on a lower tray body to restrict movement of the plurality of devices is provided on a bottom surface of the tray body.

2. The transportation tray of claim 1, wherein
a positioning mark for indicating a mounting location of each of the plurality of devices is provided on the tray body.

3. The transportation tray of claim 2, wherein
a positioning sheet marked with the positioning mark is provided between the tray body and the top surface mat.

4. The transportation tray of claim 1, wherein
the above devices are a liquid crystal display module.
